(19) United States
(12) Patent Application Publication
(10) Pub. No.: US 2002/0153311 A1
(43) Pub. Date: Oct. 24, 2002

(54) Absorbent materials and production thereof

(75) Inventor: Ian David Farquhar Davidson, Aberdeen (GB)

Correspondence Address: HESLIN ROTHENBERG FARLEY & MESITI PC, 5 COLUMBIA CIRCLE, ALBANY, NY, 12203, US

(73) Assignee: SCOTOIL GROUP PLC, Aberdeen (GB)

(21) Appl. No.: 10/098,233

(22) Filed: Mar. 15, 2002

Related U.S. Application Data
(63) Continuation of application No. PCT/GB00/03468, filed on Sep. 11, 2000.

(30) Foreign Application Priority Data
Sep. 16, 1999 (GB) 9921790.3

(51) Int. Cl. B01D 11/00

(52) U.S. Cl. 210/634; 210/747; 210/770

(57) ABSTRACT

A process for recovering clay from contaminated clay-containing waste materials e.g. drill-cuttings arising from offshore/onshore oil & gas exploration and production processes, comprises a cleaning step to generate a clay of sufficient purity for reuse, and a particle sizing step to obtain a substantially consistent quality clay product optionally in the form of bulk particles or shaped to provide conveniently transportable product forms including granules, pellets, prills, packing elements, briquettes and the like shaped articles.

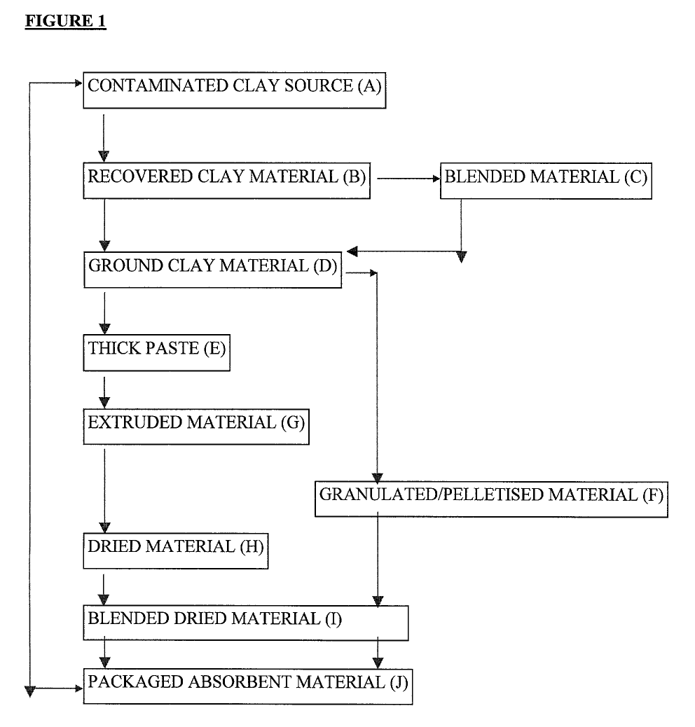

### CROSS REFERENCE TO RELATED APPLICATION

This application is a continuation of international application PCT/GB00/03468 filed Sep. 11, 2000.

### FIELD OF INVENTION

This invention relates to the handling of contaminated minerals which on account of environmental considerations currently present disposal problems. In particular the invention concerns cleaning and recovery of contaminated clay-containing materials arising from exploration and production operations conducted by the oil industry either offshore or onshore. The invention provides for the re-use of the recovered clean clay material as an absorbent product. The absorbent product obtained can be usefully employed in consumer products such as cat litter or as a commercial bulk product per se or as an additive, for example, in absorbing spillages or providing soil additives or providing a lining material for landfill or as a construction material.

### BACKGROUND OF THE INVENTION

The recovery of hydrocarbons in the form of oil and gas is a complex commercial operation conducted generally under difficult and often hazardous conditions. The fields are often in remote areas and frequently at offshore sites, and the industry is under ever increasing pressures to safeguard the environment by minimising inadvertent venting of hydrocarbons and to handle the inevitable waste by-products by efficient disposal techniques. The very remoteness of the exploration and production fields hinders efficient disposal, and disposal on-site is restricted by environmental factors.

The waste produced ranges from contaminated drilling fluids or mud to oil contaminated seawater. However in very simplistic terms the waste can generally be categorised as solids-contaminated fluids and fluid-contaminated solids. Various physical separation devices and treatment processes are operated on site but one persistent area of difficulty lies in the efficient disposal of drill cuttings.

Legislative requirements within the oil industry regarding the disposal of drill cuttings have become increasingly stringent over recent years. To meet the imposed requirements large quantities of oil contaminated cuttings have to be transported to a cleaning facility before they can be disposed of.

The cuttings originate from the drilled strata formations in the exploration for oil. These formations in a large extent of the cases will consist of shales and clays, other minerals will however be present in the strata and will be produced with the cuttings. The processes employed to drill and remove the cuttings, further contaminate the materials with oil such that they cannot be disposed of offshore, hence the requirement for cleaning.

Various methods are employed for removing the oil from these cuttings, generally a thermal or solvent wash process is utilised. The end result in each case being the production of the cuttings free of oil. Methods for handling oily cuttings are described in the literature and reference may be made to WO/91/08375 (incorporated herein by reference) where oil-contaminated cuttings are treated with solvents in conjunction with various physical separation techniques to separate solids from liquids. This is primarily concerned with addressing the problems the industry faces in avoiding or minimising oil pollution by discharge of waste in the form of oil/mud contaminated cuttings.

The problems of dealing with such drill cuttings in the face of increasing legislation and hostility to offshore dumping has tested the ingenuity of many contractors familiar with the needs of the operators in this respect. At present there are those who are attempting to deal with the problem by devising cuttings re-injection processes whereby the cuttings are returned to the field by means of an injection pump system utilising the boreholes into the hydrocarbon reservoir with varying degrees of success depending upon the skill and expertise of the personnel involved.

An object of the invention is to approach the contaminated cuttings disposal problem from another angle, namely that of utilising the waste by suitable treatments to recover materials having residual utility and potential for use in other areas of commerce. In particular it is an object of the invention to recover valuable clay materials from such waste materials, and process them for a variety of end uses.

Thus an aim of the invention is to secure the production of clay materials of sufficient quality from a previously unusable source, thereby dealing with the problem of disposal and also offering a new resource to other industries which may require an absorbent filler for example.

### SUMMARY OF THE INVENTION

According to the invention, contaminated clay materials arising from oil and gas recovery related offshore/onshore processes are cleaned to generate a clay of sufficient purity for reuse, and processed by particle sizing control techniques as required to obtain a substantially consistent quality clay product optionally in the form of bulk particles or shaped to provide conveniently transportable product forms including granules, pellets, prills, packing elements, briquettes and the like shaped articles. Conveniently the processing of the clay is controlled to obtain particles or shaped articles of high surface area to maximise the potential for use for absorbent purposes.

There are many forms of clay minerals, however those which best relate to the present invention are those classified as swelling clays:

i.e. Illite; Chlorite; Kaolinite; Montmorillonites

The present development aims to utilise the natural properties of these clays for use as absorbent fillers. This approach differs from previous processes because of the way the clay material is generated. Normally clay is mined to produce a virgin material before being processed. However, the present invention uses minerals that are by-products or waste from an alternative process as the initial source. Thus instead of presenting a costly waste accumulation or disposal problem to an efficiency and waste management conscious industry, the invention offers a positive added-value solution.

Whilst it may appear desirable to find some utility for the contaminated clay products resulting from the normal operations of drilling for hydrocarbon reserves, the industry has until now not found an acceptable option taking account of the nature of the contamination, the difficulties associated with the handling of the contaminated material, economic factors associated with transport, and storage of the materials, environmental regulations, etc. All of these factors contribute to present waste materials including drill cuttings as of no value which blocks constructive thought as to alternative uses.

Considering the contamination aspects, the clay resulting directly from routine hydrocarbon recovery operations is unsuitable for another purpose because of high levels of adulteration, with for example, other minerals, chemicals, oils or fluids.

Before these clays can be deemed useful for any other purpose they must be extracted/ cleaned/recycled by an economic and safe method, having minimal impact on the environment to produce a quality suitable for the intended purpose.

One such source of clay will stem from the routine exploration and tapping of an oilfield with the production of drill cuttings, and the invention will be described hereinbelow with reference to such a source of such clays.

### BRIEF DESCRIPTION OF THE DRAWING

The single accompanying figure illustrates schematically by way of a block flow diagram the presently contemplated mode of performance of the invention.

### MODE FOR CARRYING OUT THE INVENTION

A contaminated source of clay containing materials is identified e.g. collection of drill cuttings at an offshore hydrocarbon exploration field. Conveniently the recovered cuttings which may already have been partially cleaned or physically treated to remove excess water and/or oil are brought to an onshore facility for processing. The various phases of processing may take the following form.

STAGE 1

A: A contaminated clay source undergoes a cleaning process e.g. one such as is contemplated in WO 91/08375 to remove oil and related chemical contaminants. The combined steps of solvent washings, physical separations and drying stages to recover the clay in a dried form, are applied to an extent sufficient to obtain clay in a form and level of purity, sufficient to permit it to be processed as a non-hazardous material in an analogous fashion to virgin mineral material having regard to the intended end use.

STAGE 2

B: The recovered clay is used alone, in a dry state; or alternatively

C: The recovered clay is blended with various additives;

(Such additives include clays recovered from alternative sources e.g. waste from paper mills, wood chippings, paper, porous rock and minerals, other auxiliaries suitable or known in the field for processing or forming absorbent materials)

STAGE 3

D: The recovered clay from process phase B or the blended mixture from phase C is ground to specification or otherwise rendered in a comminuted form suitable for subsequent processing.

STAGE 4

Ground material from phase D is added to water or a water mixture (containing surfactants, deodorisers, other auxiliaries and additives which act to improve the absorbency) to form a thick paste/slurry; or alternatively

STAGE 5

F: The dry ground materials from phase D undergo granulation/pelletising to produce a suitably sized form for use as an absorbent material.

STAGE 6

G: The thick paste/slurry resulting from phase E is extruded/minced/produced into a suitably sized form for use as an absorbent material.

STAGE 7

H: The wet sized material resulting from phase G is dried sufficiently for further processing as desired.

STAGE 8

I: The dried materials obtained at phase H are optionally further blended with dyes/chalk to alter the appearance of the material.

STAGE 9

J: The dried materials are packaged for sale.

Industrial Utility

Clays recovered according to the invention are adapted for use in the manufacture of products such as the following:

1. Cat litter

2. Spillage absorber

3. Soil additive

4. Lining material for landfill/other

5. Construction material

What is claimed is:

1. A process for recovering clay from contaminated clay-containing waste materials arising from offshore/onshore processes, comprising a cleaning step to generate a clay of sufficient purity for reuse, and a particle sizing step to obtain a substantially consistent quality clay product optionally in the form of bulk particles or shaped to provide conveniently transportable product forms including granules, pellets, prills, packing elements, briquettes and the like shaped articles.

2. A process according to claim 1, wherein the particle sizing step is controlled to obtain particles or shaped articles of high surface area to maximise the potential for use for absorbent purposes.

3. A process according to claim 1, wherein the clay comprises swelling clay.

4. A process according to claim 3, wherein the clay comprises at least one of Illite; Chlorite; Kaolinite and Montmorillonites.

5. A process according to claim 1, wherein the clay is recovered from drill-cuttings.

6. A process according to claim 5, wherein the cleaning step includes the of carbonaceous contaminants, cutting fluids, lubricants, and drilling mud components.

7. A process for recovering clay from clay-containing drill-cuttings, comprising,
subjecting the clay-containing drill cuttings to treatment to remove oil and oil related contaminants therefrom, said treatment including the combined steps of solvent washings, physical separations and drying stages to recover the clay in a dried form and a level of purity sufficient to permit it to be processed as a substantially non-hazardous material; and optionally
blending the recovered clay with an additive selected from clays recovered from alternative sources, said alternative sources including at least one of wood chippings, paper, porous rock and minerals, and other auxiliaries suitable for processing or forming absorbent materials; and
comminuting the recovered clay, or a mixture of the blended clay and additive to provide a comminuted material suitable for subsequent processing.

8. A process according to claim 7, wherein the comminuted material is added to water or a water mixture containing at least one of a surfactant, deodoriser, other auxiliaries and additives which act to improve absorbency to form a thick paste/slurry.

9. A process according to claim 8, wherein the thick paste/slurry is extruded or minced or similarly produced into a suitably sized form for use as an absorbent material.

10. A process according to claim 7, wherein the comminuted material in dry condition is subjected to granulation/pelletising to produce a granulated or pelletised material in a suitably sized form for use as an absorbent material.

11. A process according to claim 10, wherein the granulated or pelletised material is blended with a dye or chalk to alter appearance of the material.

12. An absorbent material comprising a recovered clay obtained by a process according to claim 7.

13. The use of recovered clay extracted from drill cuttings in at least one of manufacture of a cat litter and production of an absorbent product.
